(19) United States
(12) Patent Application Publication
(10) Pub. No.: US 2024/0293878 A1
(43) Pub. Date: Sep. 5, 2024

(54) FIXING DEVICE FOR ROTARY SHAFT OF MILLING HEAD

(71) Applicant: Hold Well Industrial Co., Ltd., Taichung City (TW)

(72) Inventors: Kuan-Ta CHEN, Taichung City (TW); Sing-Yu Chen, Taichung City (TW)

(73) Assignee: Hold Well Industrial Co., Ltd., Taichung City (TW)

(21) Appl. No.: 18/593,141

(22) Filed: Mar. 1, 2024

(30) Foreign Application Priority Data
Mar. 3, 2023 (TW) 112107922

(51) Int. Cl. B23C 5/26

(52) U.S. Cl. CPC B23C 5/26

(57) ABSTRACT

A fixing device for a rotary shaft of a milling head includes an outer washer, an inner washer, and a locking unit. The outer washer is mounted between a housing and a first shaft, and includes an outer peripheral surface, an inner peripheral surface, and detent holes. Each detent hole is defined by a conical surface that has a bottom side portion and a top side portion. The inner washer is mounted between the outer washer and the first shaft. The locking unit includes fastening holes and adjusting members corresponding in position to the detent holes. Each adjusting member has a threaded section engaging threadedly with a corresponding fastening hole, and a conical section connected to the threaded section. The conical section has a conical pressuring surface that presses against the bottom side portion.

### CROSS-REFERENCE TO RELATED APPLICATION

This application claims priority to Taiwanese Invention Patent Application No. 112107922, filed on Mar. 3, 2023, the entire disclosure of which is incorporated by reference herein.

### FIELD

The disclosure relates to a processing machine, and more particularly to a fixing device for a rotary shaft of a milling head.

### BACKGROUND

A conventional milling head as disclosed in Chinese Patent Publication No. CN210160422U includes a housing, a cutter handle mounted in the housing, a fixing block connected to the housing, a right fixing plate mounted to the housing, a left fixing plate mounted to the housing, and a sleeve mounted in the housing and protruding out through the left fixing plate. The fixing block has a positioning pin disposed fixedly on an upper end of the fixing block. The fixing block is mounted at the bottom of a main axis of a machine tool, and the cutter handle is driven by the main axis.

While the aforementioned milling head is commonly used in applications, a bearing unit mounted in the milling head is fixed by a locking nut, and the locking nut and the bearing unit may have a gap therebetween, thereby making reduction of an overall length along an axial direction of the milling head difficult. Moreover, in terms of the cooperation between gear units, a washer is commonly used on the spot for assembly of the gear units. Assembly personnel need to measure the actual dimension of a gap to be filled by a washer, and then use a processing machine to trim the washer for fitting the actual dimension, which is a time consuming and labor intensive process.

### SUMMARY

Therefore, an object of the disclosure is to provide a fixing device for a rotary shaft of a milling head that can alleviate at least one of the drawbacks of the prior art.

According to the disclosure, for the fixing device for the rotary shaft of the milling head, the milling head includes a housing, the rotary shaft disposed axially in the housing, a gear set mounted in the housing, a first bearing set mounted in the housing, and a second bearing set mounted in the housing. The rotary shaft includes a first shaft disposed axially in the housing and supported by the first bearing set, and a second shaft disposed axially in the housing and supported by the second bearing set. The first shaft extends along a first axis, and the second shaft extends along a second axis intersecting the first axis. The gear set transmits power of the first shaft to the second shaft.

The fixing device includes an outer washer, an inner washer, and a locking unit.

The outer washer is hollow and cylindrical, is mounted between the housing and the first shaft, and includes an outer peripheral surface, an inner peripheral surface opposite to the outer peripheral surface, and a plurality of detent holes surrounding the first axis, spaced apart from each other, and in spatial communication with the outer peripheral surface and the inner peripheral surface. Each of the detent holes has a conical shape, and is defined by a conical surface that has a bottom side portion and a top side portion opposite to the bottom side portion along the first axis. Each of the detent holes has a diameter decreasing in a direction from the outer peripheral surface to the inner peripheral surface.

The inner washer is hollow and cylindrical, and is mounted between the outer washer and the first shaft.

The locking unit includes a plurality of fastening holes formed in the housing, and a plurality of adjusting members respectively corresponding to the fastening holes and respectively corresponding in position to the detent holes. Each of the adjusting members has a threaded section engaging threadedly with a corresponding one of the fastening holes, and a conical section connected to the threaded section. The conical section has a conical pressuring surface that presses against the bottom side portion. An outer diameter of the conical section decreases in a direction from an end connected to the threaded section to another end of the conical section.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an assembled perspective view illustrating an embodiment of a fixing device for a rotary shaft of a milling head according to the disclosure.

FIG. 2 is a schematic exploded perspective view of the embodiment.

FIG. 3 is a sectional view of the embodiment.

FIG. 4 is an enlarged fragmentary schematic view of FIG. 3.

FIG. 5 is another enlarged fragmentary schematic view of FIG. 3.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

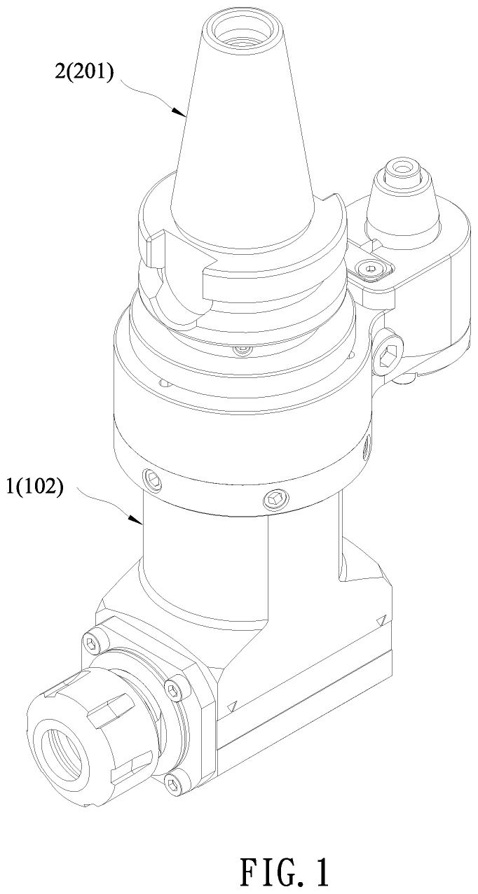

Referring to FIGS. 1 to 3, an embodiment of a fixing device for a rotary shaft of a milling head according to the present disclosure is provided. The milling head includes a housing 1, the rotary shaft 2 disposed axially in the housing 1, a gear set 3 mounted in the housing 1, a first bearing set 4 mounted in the housing 1, and a second bearing set 5 mounted in the housing 1.

The housing 1 has a first annular wall 102 surrounding a first axis (L1) and defining a first inner hole 101, and a second annular wall 104 surrounding a second axis (L2) perpendicular to the first axis (L1) and defining a second inner hole 103 that communicates with the first inner hole 101. The first inner hole 101 has a stepped shape and is defined by an inner wall surface 105 that has a small diameter section 106 adjacent to the second inner hole 103, a large diameter section 107 disposed at one side of the small diameter section 106 along the first axis (L1), and a shoulder portion 108 interconnecting the small diameter section 106 and the large diameter section 107. The second inner hole 103 has a stepped shape and is defined by an inner surrounding surface 109, which has a narrow section 109′ communicating with the first inner hole 101, a first wide section 109″ disposed at one side of the narrow section 109′ along the second axis (L2), a first abutting portion 110 interconnecting the narrow section 109′ and the first wide section 109″, a second wide section 120 disposed at another side of the narrow section 109′ along the second axis (L2), and a second abutting portion 130 interconnecting the narrow section 109′ and the second wide section 120.

The rotary shaft 2 includes a first shaft 201 disposed axially in the housing 1, and a second shaft 202 disposed axially in the housing 1. The first shaft 201 extends along the first axis (L1), and the second shaft 202 extends along the second axis (L2).

The gear set 3 transmits power of the first shaft 201 to the second shaft 202. The gear set 3 includes a first bevel gear 301 connected to the first shaft 201, and a second bevel gear 302 connected to the second shaft 202. The first bevel gear 301 and the second bevel gear 302 mesh with each other.

The first bearing set 4 has two first bearings 401 mounted in the large diameter section 107, with one of the first bearings 401 abutting against the shoulder portion 108 and another one of the first bearings 401 located at an open end of the large diameter section 107. The first shaft 201 is supported by the first bearing set 4. Each of the first bearings 401 has an outer ring 402 positioned on the inner wall surface 105, an inner ring 403 sleeved on the first shaft 201, and a plurality of balls 404 disposed between the outer ring 402 and the inner ring 403. A bottom of the outer ring 402 of the one of the first bearings 401 abuts against the shoulder portion 108.

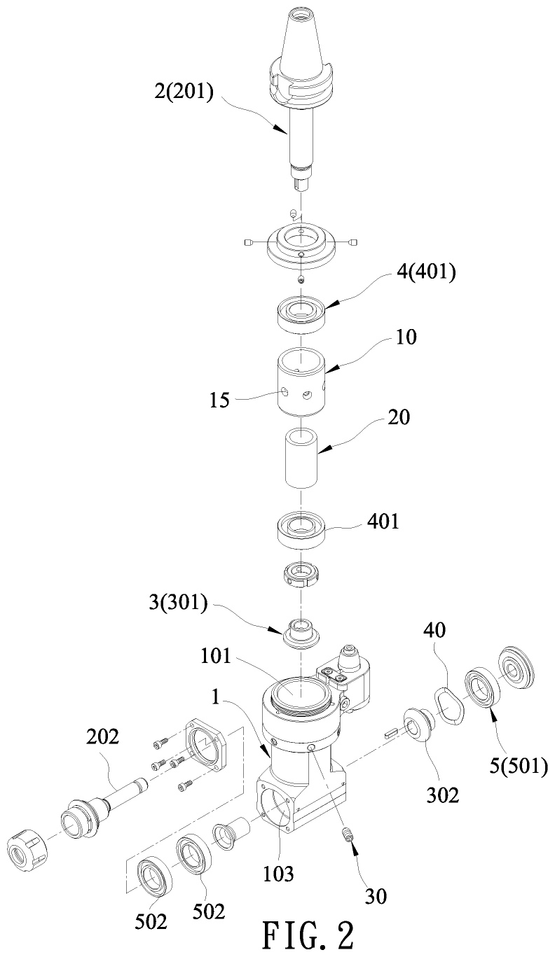

Referring to FIGS. 2, 3, and 5, the second bearing set 5 has a plurality of second bearings 501, 502 that are mounted in the second inner hole 103 and that are positioned on the second annular wall 104. The second shaft 202 is supported by the second bearing set 5. The second bearing 501 is mounted between the first wide section 109″ and the second bevel gear 302. The second bearing 501 has an outer ring 503 positioned at the first wide section 109″, an inner ring 504 sleeved on the second bevel gear 302, and a plurality of balls 505 disposed between the outer ring 503 and the inner ring 504. The second bevel gear 302 is supported by the second bearing 501. The two second bearings 502 are mounted between the second wide section 120 and the second shaft 202 with one of the second bearings 502 abutting against and positioned at the second abutting portion 130. The second shaft 202 is supported by the second bearings 502.

The fixing device includes an outer washer 10, an inner washer 20, a locking unit 30, and a wave spring 40.

The outer washer 10 is hollow and cylindrical, is mounted between the housing 1 and the first shaft 201, and has a bottom end surface 11, a top end surface 12 opposite to the bottom end surface 11 along the first axis (L1), an outer peripheral surface 13 interconnecting the bottom end surface 11 and the top end surface 12, an inner peripheral surface 14 opposite to the outer peripheral surface 13, and a plurality of detent holes 15 surrounding the first axis (L1), spaced apart from each other, and in spatial communication with the outer peripheral surface 13 and the inner peripheral surface 14. The bottom end surface 11 and the top end surface 12 abut respectively against the outer rings 402 of the first bearings 401. Each of the detent holes 15 has a conical shape, is defined by a conical surface 151 that has a bottom side portion 152 and a top side portion 153 opposite to the bottom side portion 152 along the first axis (L1). Each of the detent holes 15 has a diameter decreasing in a direction from the outer peripheral surface 13 to the inner peripheral surface 14.

The inner washer 20 is hollow and cylindrical, is mounted between the outer washer 10 and the first shaft 201. The inner washer 20 abuts against the inner rings 403 of the first bearings 401 at two opposite ends thereof along the first axis (L1).

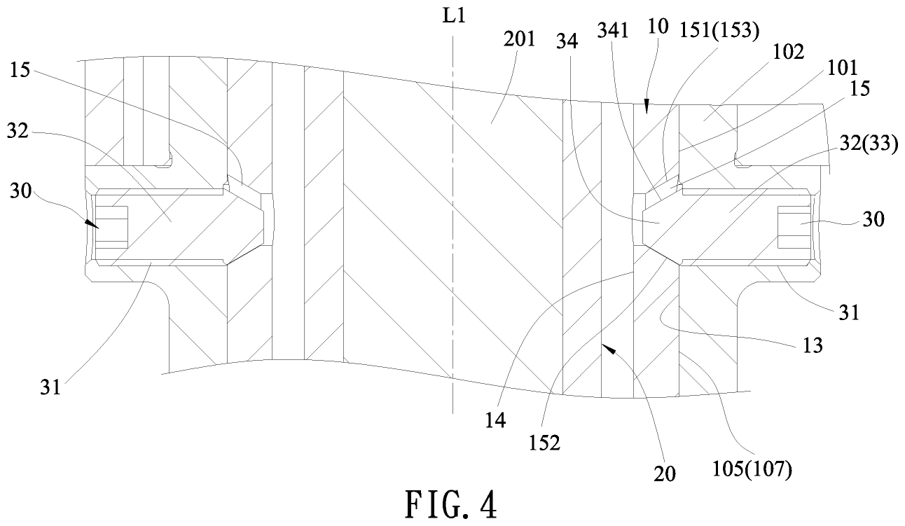

Referring to FIG. 4, the locking unit 30 includes a plurality of fastening holes 31 formed in the housing 1, and a plurality of adjusting members 32. The fastening holes 31 are threaded holes. The fastening holes 31 extend radially with respect to the first inner hole 101 and extend through the first annular wall 102. The adjusting members 32 respectively correspond to the fastening holes 31, and respectively correspond in position to the detent holes 15. Each of the adjusting members 32 has a threaded section 33 engaging threadedly in an adjustable manner with a corresponding one of the fastening holes 31, and a conical section 34 connected to the threaded section 33. The conical section 34 has a conical pressuring surface 341 that presses against the bottom side portion 152, and an outer diameter of the conical section 34 decreases in a direction from an end connected to the threaded section 33 to another end of the conical section 34. A minimum diameter of each of the detent holes 15 is greater than a minimum outer diameter of the conical section 34 of each of the adjusting members 32, and a maximum diameter of each of the detent holes 15 is greater than a maximum outer diameter of the conical section 34 of each of the adjusting members 32.

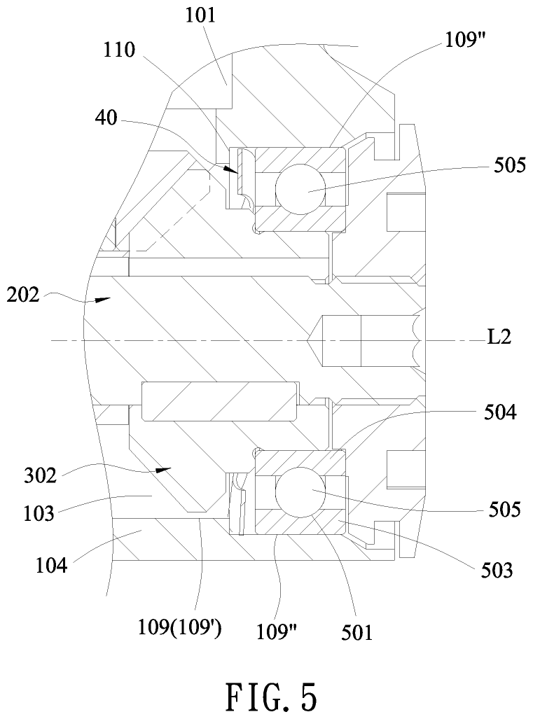

Referring to FIG. 5, the wave spring 40 is mounted between the second bearing 501 of the second bearing set 5 and the second bevel gear 302. The wave spring 40 has one end surface abutting against the first abutment portion 110, and another end surface abutting against the outer ring 503 of the second bearing 501.

To further understand the effects produced, the technical means, and the expected effects of various components of the present disclosure, detailed explanations are provided below so that a deeper and more specific understanding of the present disclosure can be obtained thereby.

As shown in FIGS. 1 and 2, when assembling the milling head of the present disclosure, the two second bearings 502 and the second shaft 202 are first mounted in the second inner hole 103, and then the second bevel gear 302, the wave spring 40, and the second bearing 501 are mounted in the second inner hole 103.

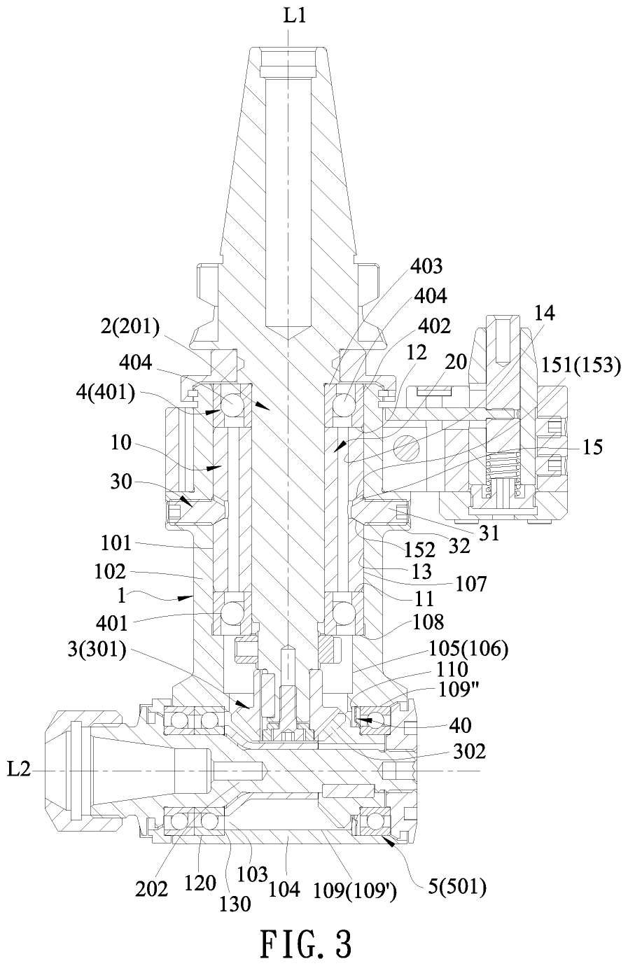

Referring to FIGS. 2 and 3, the first bearings 401, the inner washer 20, the outer washer 10, and the first bevel gear 301 are mounted on the first shaft 201. Next, the abovementioned assembly is disposed in the first inner hole 101 so that the one of the first bearings 401 is abutted against the shoulder portion 108, and the detent holes 15 are then aligned respectively with the fastening holes 31. Then, each of the adjusting members 32 is inserted from an outer side of the first annular wall 102 of the housing 1 into a corresponding one of the fastening holes 31 such that each of the threaded sections 33 is threaded to the corresponding one of the fastening holes 31, and each of the conical sections 34 gradually moves toward a corresponding one of the detent holes 15 until each of the conical pressuring surfaces 341 is pressed against the bottom side portion 152 of a respective one of the conical surfaces 151, so that when the adjusting members 32 are pressed against the bottom side portions 152 of the conical surfaces 151, a force for pushing the outer washer 10 downwardly along the first axis (L1) is generated, and the outer washer 10 is pushed against the one of the first bearings 401 so that the one of the first bearings 401 is in firm contact with the shoulder portion 108. At this time, the first bevel gear 301 is meshed with the second bevel gear 302.

Therefore, by virtue of the tightening operation of the adjusting members 32, the housing 1, the outer washer 10, and the one of the first bearings 401 may be simultaneously fixed. Since the conical sections 34 of the adjusting members 32 may generate a downward pushing force, the outer washer 10 may also be pressed against the one of the first bearings 401, so that an unnecessary distance between the outer washer 10 and the one of the first bearings 401 along the first axis (L1) may be shortened, thereby saving space.

When assembly of the milling head according to this disclosure is completed, by virtue of the first bearing set 4, the first shaft 201 may be disposed axially in a smoothly rotatable manner in the first inner hole 101 of the housing 1, and by virtue of the second bearing set 5, the second shaft 202 and the second bevel gear 302 may be disposed axially in a smoothly rotatable manner in the second inner hole 103 of the housing 1. Meanwhile, the outer washer 10 and the inner washer 20 also secure positioning of the first bearings 401 and provide stability of rotation of the first shaft 201.

In addition, by virtue of the wave spring 40 mounted between the second bearing 501 of the second bearing set 5 and the second bevel gear 302, the wave spring 40 is capable of providing preload to the second bearing 501, thereby reducing time needed for trimming the washers on the spot.

In summary, the fixing device for a rotary shaft of a milling head according to the present disclosure has a simple structure and is easy to operate, so that the object of the present disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A fixing device for a rotary shaft of a milling head, the milling head including a housing, the rotary shaft disposed axially in the housing, a gear set mounted in the housing, a first bearing set mounted in the housing, and a second bearing set mounted in the housing, the rotary shaft including a first shaft disposed axially in the housing and supported by the first bearing set, and a second shaft disposed axially in the housing and supported by the second bearing set, the first shaft extending along a first axis, the second shaft extending along a second axis intersecting the first axis, the gear set transmitting power of the first shaft to the second shaft, said fixing device comprising:
an outer washer that is hollow and cylindrical, that is mounted between the housing and the first shaft, and that has an outer peripheral surface, an inner peripheral surface opposite to said outer peripheral surface, and a plurality of detent holes surrounding the first axis, spaced apart from each other, and in spatial communication with said outer peripheral surface and said inner peripheral surface, each of said detent holes having a conical shape, and being defined by a conical surface that has a bottom side portion and a top side portion opposite to said bottom side portion along the first axis, each of said detent holes having a diameter decreasing in a direction from said outer peripheral surface to said inner peripheral surface;
an inner washer that is hollow and cylindrical, and that is mounted between said outer washer and the first shaft; and
a locking unit that includes a plurality of fastening holes formed in the housing, and a plurality of adjusting members respectively corresponding to said fastening holes and respectively corresponding in position to said detent holes, each of said adjusting members having a threaded section engaging threadedly with a corresponding one of said fastening holes, and a conical section connected to said threaded section, said conical section having a conical pressuring surface that presses against said bottom side portion, an outer diameter of said conical section decreasing in a direction from an end connected to said threaded section to another end of said conical section.

2. The fixing device for a rotary shaft of a milling head as claimed in claim 1, the gear set including a first bevel gear connected to the first shaft, and a second bevel gear connected to the second shaft, the first bevel gear and the second bevel gear meshing with each other, said fixing device further comprising a wave spring mounted between the second bearing set and the second bevel gear.

3. The fixing device for a rotary shaft of a milling head as claimed in claim 2, the second bearing set including a plurality of second bearings, one of the second bearings having an outer ring positioned at the housing, an inner ring sleeved on the second bevel gear, and a plurality of balls disposed between the outer ring and the inner ring, the second bevel gear being supported by the one of the second bearings, wherein said wave spring has one end surface abutting against the housing and another end surface abutting against the outer ring of the one of the second bearings.

4. The fixing device for a rotary shaft of a milling head as claimed in claim 1, wherein a minimum diameter of each of said detent holes of said outer washer is greater than a minimum outer diameter of said conical section of each of said adjusting members, a maximum diameter of each of said detent holes being greater than a maximum outer diameter of said conical section of each of said adjusting members.
